(19) United States
(12) Patent Application Publication
(10) Pub. No.: US 2022/0224984 A1
(43) Pub. Date: Jul. 14, 2022

(54) Automatic Detection For End of Current Program and Trigger Events

(71) Applicant: BBY Solutions, Inc., Richfield, MN (US)

(72) Inventors: Jinyuan Liu, Ganzhou City (CN); Rain Grimm, Savage, MN (US)

(73) Assignee: BBY Solutions, Inc., Richfield, MN (US)

(21) Appl. No.: 17/147,898

(22) Filed: Jan. 13, 2021

(51) Int. Cl. H04N 21/472; H04N 21/41; G16Y 40/30

(52) U.S. Cl. CPC H04N 21/47217; G16Y 40/30; H04N 21/41265

(57) ABSTRACT

A controller and digital media player such as a television equipped with such a controller is disclosed. The controller provides for determining the end time of a program currently being played on the television and then triggering at least one trigger event to occur upon the end of the program currently being played. The controller is in communication with an ACR database, and is capable of determining program end times using ACR matching, EPG data of over-the-air broadcasts, and by the detecting of program end credits. Trigger events may vary, but include shutting the television off, and instructing other smart devices in communication with the controller to initiate various functions (turn on, turn off, open, close, send a message, etc.).

### FIELD OF THE INVENTION

Embodiments disclosed herein are directed to systems and methods for detecting the end of a program being played on a media player such as a television, digital video recorder (DVR), set-top box, streaming box, music player, etc. and based on that detected ending causing one or more subsequent functions to be triggered in the media player and/or in an electronic device connected therewith.

### BACKGROUND OF THE INVENTION

Multiple technologies exist to allow a media player to automatically detect the end of a program currently being played on the media player. Systems such as Electronic Programming Guides (EPGs) allow the media player to access program information associated with a digital program such as the current program's end time. Automatic Content Recognition (ACR) systems are capable of identifying any programming played by the media player by selecting a clip of the content playing and sending that clip to a database server via the internet. The clip is compared to clips stored on the database to form a match between the stored programming and the clip. The server then sends back information to the media player regarding the program being played such as where the program is at in terms of its duration and how much time the program has until it ends.

Other systems include providing a media player with the ability to recognize tags associated with program ending credits, upon which the media player can then estimate the expected end time of the program thereafter.

Having the capability to determine the end of the program playing is of little value as most current media player devices fail to provide a trigger functionality based on the end time of the current program being played.

Some devices do provide trigger functionality, but do so based on estimated time functionality. For example, a current technology common to modern digital television sets are so-called “sleep timers” which allow a user watching a program 100, an example of which is illustrated in PRIOR ART FIG. 1, to access a television on screen display (OSD) 102, such as that which is illustrated in PRIOR ART FIG. 2, to select from a menu 104 of indicated periods of time (e.g. 5 minutes, 10 minutes, etc.) 106 to shut-off the television or place the television into a sleep mode.

The available time periods 106 from which the user may select do not necessarily correspond to the actual end time 108, shown in PRIOR ART FIG. 1, of the program 100 currently being played, and as such, the user is forced to approximate the time that they wish the television to be shut-off or be placed in a sleep mode. Such approximation may result in the television staying on beyond the actual end time of the program, or being shut-off prematurely and interrupting the user's enjoyment of the program that they were viewing.

Not only are such sleep timer mechanisms inefficient, but they are also extremely limited in that they merely provide for a single trigger event, namely shutting the television off.

A need exists to provide a media player with the ability to accurately determine the end time of a program currently being played and then to provide a trigger mechanism based on the determined end time to easily and/or automatically trigger an event, in the media player itself, or in other smart devices electronically linked to the media player, upon the ending of the current program being played.

### SUMMARY OF THE INVENTION

Embodiments of the media player device and systems disclosed herein include a mechanism for automatically triggering an event, such as to turn off the device, and/or other events to automatically occur upon the ending of the current program being played. The devices and systems disclosed herein include a software based control mechanism that will automatically calculate or determine the end time of the current program being played, set an internal timer accordingly, and then trigger one or more events in the media player, and/or in devices connected to the media player, to occur with accuracy and automated convenience.

### BRIEF DESCRIPTION OF THE SEVERAL VIEWS OF THE DRAWINGS

PRIOR ART FIG. 1 is a depiction of a screen of a conventional digital television displaying programing.

PRIOR ART FIG. 2 is a depiction of a sleep timer function of the digital television shown in PRIOR ART FIG. 1.

FIG. 3 is a block diagram view of a home network of wifi connected devices including a media player (television) incorporating an end time determination and event triggering controller, and connected via internet to an offsite database.

FIG. 4. is a block diagram view of the television shown in FIG. 3 connected to the offsite database via a program provider.

FIG. 5 is a depiction of a an embodiment of an on screen display of a television equipped with an end time determination and event triggering controller.

FIG. 6 is a flowchart showing the functionality of the end time determination and event triggering controller.

FIG. 7 is a depiction of a user interface menu overlay shown displayed over programing shown on the screen of a television equipped with an end time determination and event triggering controller.

FIG. 8 is a user interface table featuring example ancillary “smart” devices connected to a television equipped with an end time determination and event triggering controller and their respective example trigger events.

### DETAILED DESCRIPTION

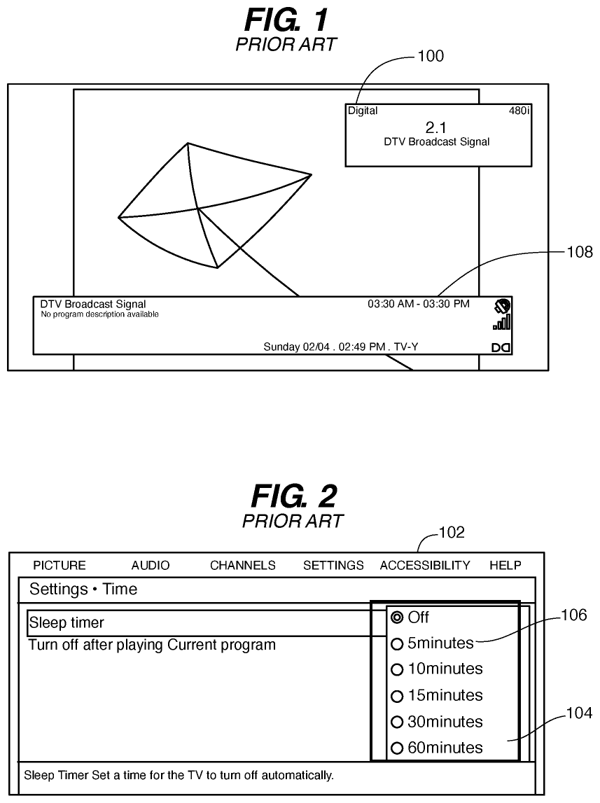

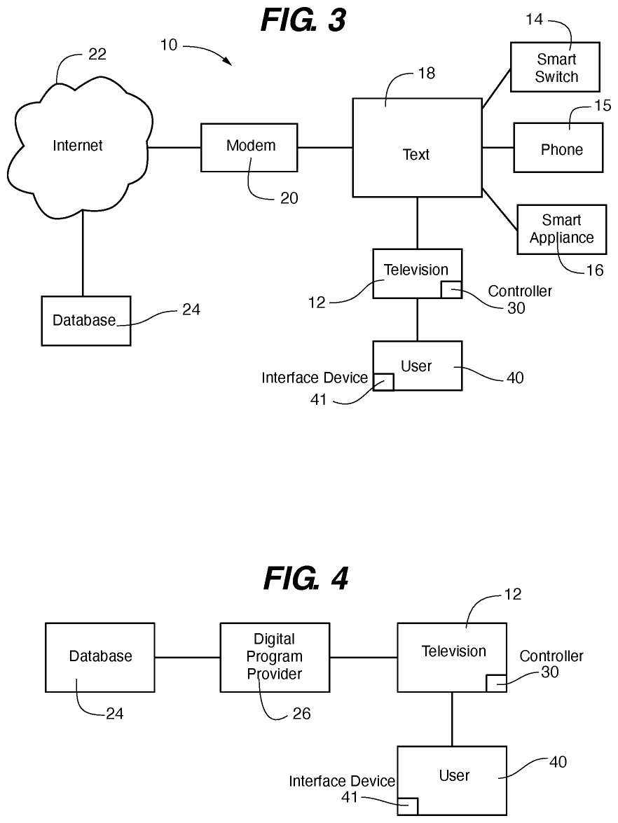

In a modern home entertainment environment such as is depicted in FIG. 3, a home network system 10 may include a plurality of interconnected “smart” devices such as a digital media player (in this example a television) 12, smart lighting fixtures or switches 14, one or more smart phones 15, smart blinds, curtains or other smart appliances 16. Other such interconnected smart devices (not shown) may include smart speakers of various types as well as home computer systems, among others. These network connected smart devices are in communication with one another via a wifi enabled router 18. Router 18 is connected to (or may incorporate) a modem 20, which provides the network 10 with access to the internet 22.

With access to the internet 22, individual smart devices, and particularly digital television 12 can communicate with devices outside of the network 10, such as for example an ACR database 24.

Alternatively, such as in the manner shown in FIG. 4 a digital television 12 that is not part of an internet accessible home network may still communicate with an ACR (or other external device) database 24 via subscription to a digital program provider 26.

Be it by direct communication via the internet 22 or by access granted via a program provider 26, the television 12 may access the ACR database 24 via a controller 30 that includes software for communicating with the ACR database, accessing its records and conducting the program matching necessary for the controller 30 to determine what program is currently being played, and what the program's end time will be.

Absent a communication path to an ACR database 24, the controller 30 of the television 12 is also configured to access EPG data contained in over-the-air programming and determine the current program end time via such information.

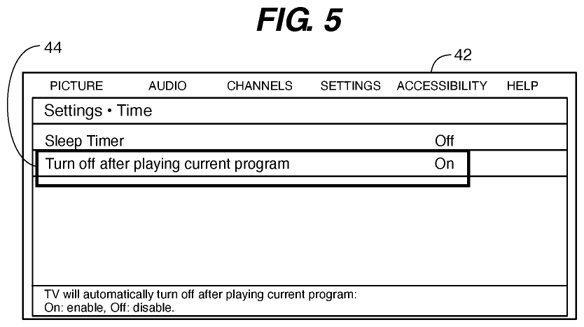

Once the controller 30 has determined the end time of the current program via ACR program matching or EPG information, a user 40 may then via a remote control or other interface device 41 access an OSD menu 42 such as of the type shown in FIG. 5 to activate the trigger event 44 of shutting off the television after the current program ends rather than using the more crudely accurate sleep timer mechanism previously discussed.

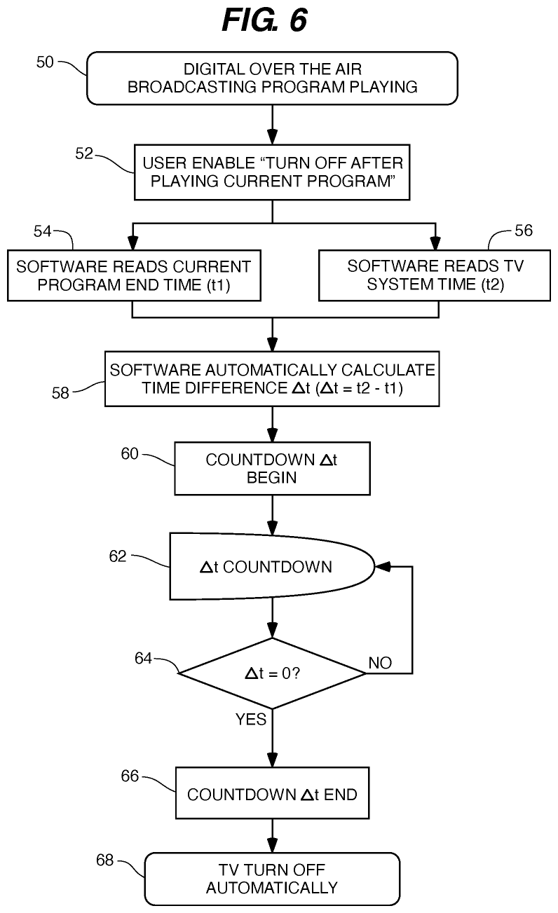

The particular manner in which the end time determination of the current program is determined and the trigger event 44 is activated and implemented is shown in the block diagram, flow chart of FIG. 6.

At block or step one 50, a program is playing on the television 12. That program may have originated from a variety of sources such as for example a cable or satellite provider, a digital stream, an over the air broadcast, etc.

At block 52, the user 40 (as shown in FIGS. 3-4) accesses the television's OSD menu 42 (shown in FIG. 5) to select the “turn off after playing current program” trigger event 44 (also shown in FIG. 5). The controller 30 (shown in FIGS. 3-4) then at block 54 detects of the program being played an over-the-air broadcast or from a different source and the reads the current program end time (t1) EPG information access or ACR matching via the ACR database 22 (shown in FIGS. 3-4). At block 56, the controller 30 detects the television's internally programmed/displayed time (t2).

At block 58, the controller 30 calculates the time difference (Δt), where time difference (Δt) is equal to the television's displayed time (t2) minus the detected end time (t1) of the current program. Having calculated the difference in time between the television's time and the detected program end time, at block 60 the controller 30 begins a time difference countdown. At block 62, 64 and the controller continues to query whether or not the time difference count down has reached zero. When the time difference equals zero query is “yes” the countdown ends at block 66, and the controller 30 turns television 12 off and block 68.

As an alternative to the sequence illustrated in FIG. 6, in some embodiments, when the user 40 activates the “turn off after playing current program” trigger event 44 (block 52), the controller 30 will detect when the end credits of the current program begin to play. Once these credits begin, or at some predetermined interval thereafter, the controller will activate the trigger event 42 and turn off the television.

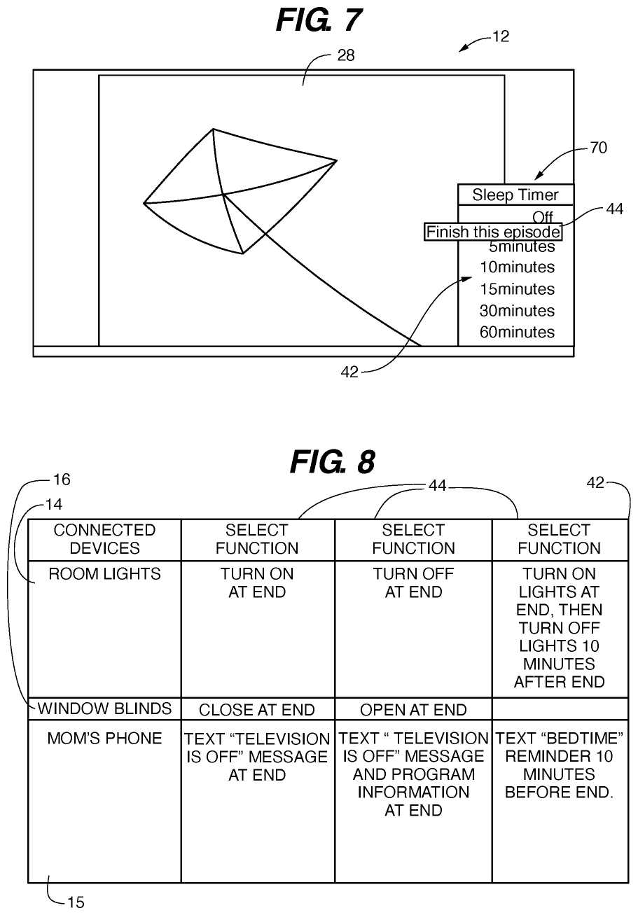

In FIG. 7 an example of television 12 playing a program 28 is shown. An example user interface 70 of the OSD menu 42 is shown overlaid on the displayed program 28. Via this interface the user may activate the functions of the controller 30 (shown in FIGS. 3-4) as described above and shown in FIG. 6.

The trigger event 44 or turning the television 12 off after the current program ends is but one example of a trigger event 44 that the controller 30 may activate. In at least one embodiment, the television interface 70 and/or the OSD menu 42 may provide the user 40 with any of a variety of possible trigger events such as for example, causing a connected device such as a digital video recorder (which may be incorporated into the television 12 or be a separate stand-alone device), to record a program following the completion of the end of the current program being played.

As previously mentioned, where the television 12, is incorporated into a home network 10 (see FIG. 3) of multiple interconnected smart devices, the controller 30 may provide an OSD menu 42 which includes possible trigger events 44 that the controller 30 may impose upon such connected devices. For example, an OSD menu 42 is shown in FIG. 8 where smart devices other than the television 12, and which are are connected to the network 10, are displayed to the user 40 along with a selection of functions or trigger events 44 associated with each device that a user my select from.

Via this OSD menu 42, a user may select from the connected devices, including: the smart “room lights” (or switches) 14, “Mom's phone” 15, and smart window blinds 16, etc. For each connected device, the user my select from a menu of desired trigger actions 44 which are to occur at the end of the current program, along with the turning off of the television 12 (if selected by the user via the OSD 42 shown in FIG. 5) or in place of such a trigger event (if it is not selected). Such potential trigger events 44 include functions such as: turn on the lights, turn off the lights, open the blinds, close the blinds, text Mom's phone that the television is off, test Mom's phone a message that the television is off and include with that text information regarding the program that has just concluded, etc. Depending on the nature of the smart devices connected to the network 10 (see FIGS. 3-4) the controller 30 may provide the user 40 with any number and variety of possible trigger events 44, and even provide for customizable events to be created by the user 40.

For example, where multiple smart light fixtures are connected, say for example four lights, a custom trigger event 44 might be “turn on lights one and four to fifty percent illumination, turn on lights two and three to full illumination.” Such customized trigger events are created by the user and input into the controller 30 via the user interface 70 (see FIG. 7) or remote control 41 (see FIGS. 3-4).

The many features and advantages of the invention are apparent from the above description. Numerous modifications and variations will readily occur to those skilled in the art. Since such modifications are possible, the invention is not to be limited to the exact construction and operation illustrated and described. Rather, the present invention should be limited only by the following claims.

1. A hardware digital media player having a controller for determining the end time of a program currently being played on the media player and then triggering at least one trigger event upon the end of the program currently being played, the controller in communication with an ACR database, the controller constructed and arranged to carry out the following steps:
a) detecting that the program currently being played is currently being played on the digital media player;
b) receiving a user initiated command to activate the at least one trigger event;
c) determining the origin of the program and detect the program end time (t1) via ACR matching;
d) determining the displayed time (t2) by the digital media player;
e) calculating the difference in time (Δt) by subtracting the end time (t1) form the displayed time (t2);
f) initiating a countdown of the difference in time (t);
g) detecting that the countdown of the difference in time has reached zero; and
h) initiating the at least one trigger event.

2. The hardware digital media player of claim 1 wherein the digital media player is a television.

3. The hardware digital media player of claim 2 wherein the television is part of a home network of interconnected devices, including a router and modem connected to the internet.

4. The hardware digital media player of claim 3 wherein the at least one trigger event is turning off the hardware digital media player at the end of the program currently being played.

5. The hardware digital media player of claim 4 wherein the home network further comprises at least one smart device, the controller being in communication with the at least one smart device.

6. The hardware digital media player of claim 5 wherein the at least one trigger event is a functional instruction imposed upon the at least one smart device.

7. The hardware digital media player of claim 3 wherein the at least one smart device is selected from the group consisting of smart phones, smart fixtures, smart switches, smart speakers, smart appliances, home computers, and any combination thereof.

8. The hardware digital media player of claim 1, wherein step c) includes detecting the program end time (t1) via the detection of the program credits being played.

9. A hardware controller for determining the end time of a program currently being played on a digital media player and triggering at least one trigger event upon the end of the program currently being played, the controller in communication with an ACR database, the controller constructed and arranged to carry out the following steps:
a) detecting that the program currently being played on the digital media player;
b) receiving a user initiated command to activate the at least one trigger event;
c) determining the origin of the program and detect the program end time (t1) via ACR matching;
d) determining the displayed time (t2) by the digital media player;
e) calculating the difference in time (Δt) by subtracting the end time (t1) form the displayed time (t2);
f) initiating a countdown of the difference in time (t);
g) detecting that the countdown of the difference in time has reached zero; and
h) initiating the at least one trigger event.

10. The hardware controller of claim 9, wherein the controller is part of the digital media player.

11. The hardware controller of claim 10, wherein the digital media player is a television.

12. The hardware controller of claim 11, wherein the television is connected to the ACR database via a subscription provided by a digital programing provider.

13. The hardware controller of claim 11, wherein the television is part of a home network of interconnected devices, including a router and modem connected to the internet, and at least one smart device.

14. The hardware controller of claim 13, wherein the at least one trigger event is turning off the television at the end of the program currently being played

15. The hardware controller of claim 14, wherein the at least one trigger event is a functional instruction imposed upon the at least one smart device.
